(19) United States
(12) Patent Application Publication
(10) Pub. No.: US 2004/0194359 A1
(43) Pub. Date: Oct. 7, 2004

(54) Attachment plate of a flexible, bendable material

(76) Inventor: Kennth Sharp, Skarholmen (SE)

Correspondence Address: FASTH LAW OFFICES, 629 E. BOCA RATON ROAD, PHOENIX, AZ, 85022, US

(21) Appl. No.: 10/757,110

(22) Filed: Jan. 14, 2004

(30) Foreign Application Priority Data
Apr. 1, 2003 (SE) 0300942-0

(51) Int. Cl. G09F 3/00; G09F 3/10

(52) U.S. Cl. 40/315; 40/673

(57) ABSTRACT

The present invention relates to an attachment plate (2) of a flexible, bendable material adapted for attachment to fabric, cables, flower stalks or similar items. The attachment plate has two tongue shaped portions including a first tongue (4, 20) and a second tongue (6, 21) formed by a perforation in the plate so that a foot portion (8, 9) of each tongue shaped portion is held to the plate while each respective tongue shaped portion, extending from the foot portion to an outer free end (10, 11; 22, 23) of each tongue shaped portion, respectively, is outwardly bendable from the plate and the outer free ends of the tongue shaped portions are immediately adjacent to one another at a slit (12, 24) formed by a perforation. The outer free end (10, 11; 22, 23) of each respective tongue shaped portion (4, 20; 6, 21) has at least one narrowing portion (14, 14′; 15, 15′) so that each respective narrowing portion is adapted to at least partially overlap the other narrowing portion at the slits (12, 24).

### TECHNICAL FIELD

The present invention relates to an attachment plate of a flexible, bendable material that is adapted for attachment to fabric, cables, flower stalks or similar items.

### BACKGROUND

Signs, cards, card holders and plates with attachment arrangement for attachment to clothing are previously known. A couple of known attachment arrangements for a sign are for example the commonly used name badges used at exhibitions, conferences, courses and stores or similar applications. An attachment arrangement for such a name tag is usually in the form of a safety pin, clip or needle with an attachment plate (so called pin) arranged on a backside of the plate. These tags should quickly and easily be attached to clothing of the bearer and be removable in an uncomplicated way without damaging the clothing at the attachment points. When making such name tags the attachment arrangement must be attached to the tag and also extend along the backside of the tag.

DE-U1-9016614 shows a card of paper with a cavity that is adapted to be attached to an item such as a button. The card includes a U-shaped slit in which a business card can be inserted and held therein.

A problem with the above publication is that the actual attachment arrangement of the card/sign limits the area of use i.e. which type of items the card/sign can be attached to and that portions of the item to which the sign or card is attached to extend on the front side of the card/sign.

### SUMMARY OF THE INVENTION

One object of the present invention is to provide a sign/plate with an attachment arrangement that at least partially eliminates the drawbacks that are associated with the arrangements of the prior art. An additional object is to provide a sign/plate with an attachment arrangement that is easy to attach to different types of items and can be produced at a low cost. A further object is to provide a sign/plate with an attachment arrangement that only substantially extends in an extension plane. The sign/plate does not have an attachment arrangement that substantially extends across the extension plane of the sign/plate and that prevents portions of the item, to the side to which the sign/plate is attached, to extend on the second opposite side of the sign.

The object is achieved by an attachment plate of a flexible, bendable material adapted for attachment to fabric, cables, flower stalks or similar items according to the present invention as defined in patent claim 1. The attachment plate has two tongue-shaped portions including a first tongue and a second tongue formed by a perforation in the plate so that a foot portion of each tongue-shaped portion is held to the plate while each respective tongue-shaped portion, extending from the foot portion to an outer free end of each tongue-shaped portion, respectively, is outwardly bendable from the plate and the outer free ends of the tongue-shaped portions are immediately adjacent to one another at a slit formed by a perforation. The outer free end of each respective tongue shaped portion has at least one narrowing portion so that each respective narrowing portion is adapted to at least partially overlap the other narrowing portion at the slits.

The attachment plate of the present invention can be a name tag, a business card or a card in the form of a credit card or a similar item. The tongue-shaped portions and the slit disposed therebetween is the actual attachment mechanism of the attachment plate.

An advantage with this solution according to the present invention is that the attachment arrangement is integrated into the attachment plate and that the attachment plate substantially extends only in the extension plane of the plate. An advantage of the present invention is thus that the attachment plate eliminates the need for applying a separate attachment mechanism to the plate. The attachment mechanism of the attachment plate is shaped so that it can be attached to items with varied shapes and dimensions such as fabric/clothing, a cable, flower stalk etc. Yet another advantage is that the attachment plate makes it possible to produce the plate at a low manufacturing cost.

Different areas of use of the attachment plate can include attachment to a glass such as wine glass, champagne glass etc. at, for example, arrangements with table placing. The attachment plate can be in the form of a card that is attached to a flower stalk, a name tag that is attached to fabric/clothing and so on.

The attachment plate is of a flexible, bendable material such as plastics, metal, paper or cardboard.

Additional advantages and characteristics according to the embodiments of the invention are apparent in view of the patent claims and in the following description of the embodiments.

### BRIEF DESCRIPTION OF THE DRAWINGS

The invention is now described in more detail with reference to the appended drawings and the invention is not to be interpreted to be limited to the drawings in which

FIG. 1 schematically shows a plane top view of an attachment plate according to the present invention,

FIG. 2 shows an elevational side view of the attachment plate according to FIG. 1 when the entire attachment plate is bent,

FIG. 3 shows an elevational side view of the attachment plate according to FIG. 1 attached to a button on a fabric, and

FIG. 4 shows a plane top view of an alternative embodiment of an attachment plate according to the present invention.

### DETAILED DESCRIPTION OF PREFERRED EMBODIMENTS

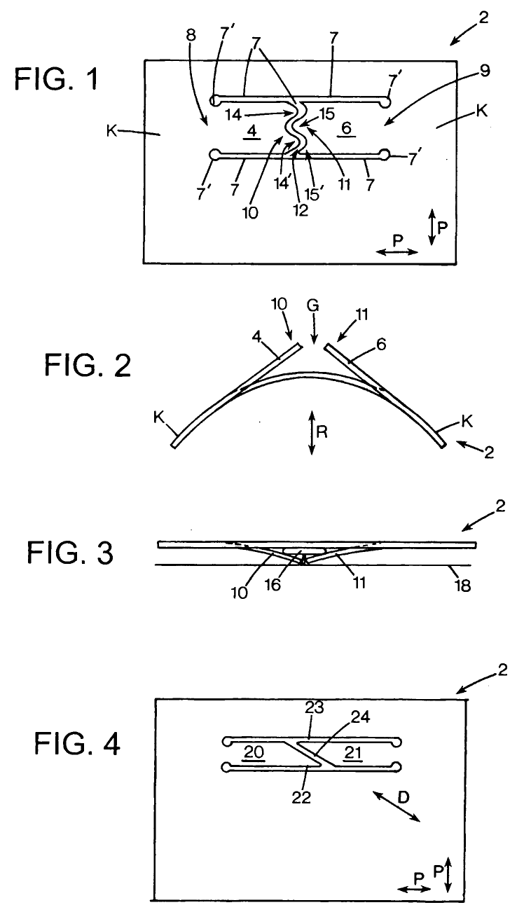

An attachment plate 2 is shown in FIGS. 1-4 according to the embodiments of the present invention. The attachment plate has at least two tongue shaped portions extending in opposite directions, a first tongue 4 and a second tongue 6. The tongue shaped portions 4, 6 are limited by slits 7 of the attachment plate that, when undivided, extend from the edge areas K of the plate and towards one another. The tongue shaped portions are shaped by the perforations of the plate 2 so that a foot portion 8, 9 of each tongue shaped portion 4, 6, respectively, is held to and by the plate 2. The tongue shaped portions 4, 6 are, from the foot portion 8, 9 to an outer free end 10, 11 of each tongue shaped portion flexible and bendable in a direction R (see FIG. 2) across the extension plane P of the plate (see FIGS. 1 and 4). The slits end at an opening 7′ at the foot portions 8, 9.

Furthermore, the outer free ends 10, 11 of the tongue shaped portions 4, 5 are immediately adjacent to one another at a slit 12 formed by a perforation. The outer free end 10, 11 of each respective tongue shaped portion is shaped so that it has at least one narrowing portion 14, 15. Each respective narrowing portion 14, 15 is adapted to, at least partially, overlap the other at the slit 12. As shown in FIGS. 1-4 the overlap means that one narrowing portion 14 of the first tongue shaped portion 4 extends toward the foot portion 9 of the opposite second tongue shaped portion 6 and vice versa so that a narrowing portion 15 of the second tongue shaped portion 6 extends towards the foot portion 8 of the first tongue shaped portion 4.

The attachment plate (see FIG. 1) has, according to one embodiment, outer free ends 10, 11 of each tongue shaped portion 4, 6, respectively, that are shaped with at least two narrowing portions 14, 14′, 15, 15′. The tongue shaped portion can, when disposed immediately adjacent to one another, form a wave shaped slit, as shown in FIG. 1, along the slits 12.

The attachment plate 2 is of a flexible, bendable material. FIG. 2 shows how the attachment plate, according to FIG. 1, is applied to an item by bending the plate. When bending the entire attachment plate 2, each respective tongue shaped portion is bent in the direction R out from the plate across the extension plane P of the plate (see FIG. 1). In this way, the free ends 10, 11 of the tongue shaped portion, when bending the entire attachment plate in a direction that corresponds with the tongue shaped portions, as opposed to the rest of the plate, are substantially unbent. By forming a gap G between the outer free ends 10, 11, the plate is with its tongue shaped portions fastenable to the bearer, such as the jacket of the person since the flexible plate is permitted to return to its plane extension (see FIG. 1).

FIG. 3 shows the attachment plate 2 according to FIGS. 1-2 attached to a button 16 on a fabric 18. The attachment plate is preferably also suitable for attachment to fabric but can also be attached to other soft surfaces of an item and also to thin and narrow portions of items such as sheets or similar items.

FIG. 4 shows an alternative embodiment of the tongue shaped portions 20, 21 for the attachment plate 2 according to the present invention that can be particularly suitable for attaching the attachment plate to elongate items such as cables, blower stalks or similar items. This attachment plate is characterized in that the outer free end 22, 23 of each tongue shaped portion 20, 21, respectively, is formed with a continuously narrowing portion so that the formed slits 24 has a substantially straight, diagonal extension D, i.e. diagonal relative to the direction of the extending tongue shaped portions.

1. An attachment plate (2) of a flexible, bendable material adapted for attachment to fabric, cables, flower stalks or similar items, the attachment plate having two tongue shaped portions including a first tongue (4, 20) and a second tongue (6, 21) formed by a perforation in the plate so that a foot portion (8, 9) of each tongue shaped portion is held to the plate while each respective tongue shaped portion, extending from the foot portion to an outer free end (10, 11; 22, 23) of each tongue shaped portion, respectively, is outwardly bendable from the plate and the outer free ends of the tongue shaped portions are immediately adjacent to one another at a slit (12, 24) formed by a perforation, characterized therein that the outer free end (10, 11; 22, 23) of each respective tongue shaped portion (4, 20; 6, 21) has at least one narrowing portion (14, 14′; 15, 15′) so that each respective narrowing portion is adapted to at least partially overlap the other narrowing portion at the slits (12, 24).

2. The attachment plate according to patent claim 1 characterized therein that the outer free end (10, 11) of each respective tongue shaped portion (4, 6) has at least two narrowing portions (14, 14′; 15, 15′).

3. The attachment plate according to patent claim 1 characterized therein that immediately adjacent to one another the tongue shaped portions (4, 6) form a wave shaped slit along the formed slit (12).

4. The attachment plate according to patent claim 1 characterized therein that the outer free end (22, 23) of each respective tongue shaped portion (20, 21) has a continuously narrowing portion so that the formed slit (24) has a substantially straight, diagonal extension (D).

5. An attachment plate of a bendable material, comprising:
a first tongue shaped portion (4, 20) and a second tongue shaped portion (6, 21) formed by a weakened segment in the attachment plate so that a first foot portion (8) of the first tongue shaped portion and a second foot portion (9) of the second tongue shaped portion are being held to the attachment plate;
the first tongue portion extending from the first foot portion to a first outer free end (10, 22);
the second tongue portion extending for the second foot portion to a second outer free end (11, 23);
the attachment plate is bendable relative to the first and second tongue portions;
the first outer free end being adjacent to the second free end at a slit (12, 24) formed by the weakened segment.

6. The attachment plate according to claim 5 wherein the first protruding portion has a first narrowing outer end and the second protruding portion has a second narrowing outer end.

7. The attachment plate according to claim 6 wherein the first narrowing outer end extends into a first cavity of the second outer end of the second tongue portion.

8. The attachment plate according to claim 5 wherein the second protruding portion overlaps the first protruding portion.

9. The attachment plate according to claim 5 wherein the first tongue portion extends in a first direction and the second tongue portion extends in a second direction opposite the first direction.

10. The attachment plate according to claim 5 wherein the first outer end is separable from the second outer end when the attachment plate is in a bent position and the first outer end being immediately adjacent to the second outer end when the attachment plate is in a straight relaxed position.

11. The attachment plate according to claim 1 wherein the first outer free end has a first protruding portion and the second outer free end has a second protruding portion aligned with the first protruding portion at the slit.
